(19) United States
(12) Patent Application Publication
(10) Pub. No.: US 2015/0283704 A1
(43) Pub. Date: Oct. 8, 2015

(54) INFORMATION PROCESSING APPARATUS AND INFORMATION PROCESSING METHOD

(71) Applicant: CANON KABUSHIKI KAISHA, Tokyo (JP)

(72) Inventor: Daisuke Watanabe, Yokohama-shi (JP)

(21) Appl. No.: 14/679,966

(22) Filed: Apr. 6, 2015

(30) Foreign Application Priority Data
Apr. 7, 2014 (JP) 2014-078710

(51) Int. Cl. B25J 9/16; G06F 17/16

(52) U.S. Cl. CPC B25J 9/1612; G06F 17/16; B25J 9/1697; G05B 2219/40512; G05B 2219/40583; Y10S 901/47; G05B 2219/37555

(57) ABSTRACT

In order to reliably and efficiently teach a robot hand a position-and-orientation allowing the robot hand to approach a work a three-dimensional position-and-orientation of which is recognized by a vision system, an information processing apparatus includes a position-and-orientation acquisition unit configured to acquire a position-and-orientation of a holding unit in a state where the holding unit holds a target object, a target object position-and-orientation acquisition unit configured to acquire a position-and-orientation of the target object in a state where the target object is held by the holding unit, and a derivation unit configured to derive a relative position-and-orientation of the holding unit and the target object based on the position-and-orientation of the holding unit acquired by the position-and-orientation acquisition unit and the position-and-orientation of the target object acquired by the target object position-and-orientation acquisition unit.

### BACKGROUND OF THE INVENTION

1. Field of the Invention

The present invention relates to a control method of an information processing apparatus for acquiring a gripping position-and-orientation to grip a target object with a robot hand.

2. Description of the Related Art

In recent years, there has been developed a technique for a robot picking up and gripping a stacked work (i.e., target object) with a robot hand attached to the robot by recognizing a three-dimensional position-and-orientation of a work stacked on a production line of a factory. Because each work is stacked in an arbitrary position-and-orientation, it is necessary to change a position-and-orientation of the robot hand according to the position-and-orientation of the work in order to execute a grip operation.

According to a technique discussed in Japanese Patent Application Laid-Open No. 2011-177808, a position-and-orientation of a robot hand when gripping a work on a simulator is defined. In other words, after inputting models of the work and the robot hand to the simulator, a user defines a position-and-orientation for gripping the work with the robot hand or releasing the work therefrom at a target position by operating the input models with a mouse or a keyboard.

However, according to the method discussed in Japanese Patent Application Laid-Open No. 2011-177808, because the position-and-orientation is only defined on the simulator, contact or friction between the work and the robot hand, and deviation in the gravity center thereof are not taken into consideration. Further, there may be a case where the models of the robot hand and the work input to the simulator are different from the actual robot hand and the work. Therefore, the user may fail to grip the actual work when the user tries to grip the work according to a gripping position-and-orientation of the robot hand defined on the simulator.

### SUMMARY OF THE INVENTION

The present invention is directed to an information processing apparatus and an information processing method capable of acquiring more precisely a position-and-orientation of a robot hand for gripping a work.

According to an aspect of the present invention, an information processing apparatus includes a position-and-orientation acquisition unit configured to acquire a position-and-orientation of a holding unit in a state of holding a target object, a target object position-and-orientation acquisition unit configured to acquire a position-and-orientation of the target object in a state of being held by the holding unit, and a derivation unit configured to derive a relative position-and-orientation of the holding unit and the target object based on the position-and-orientation of the holding unit acquired by the position-and-orientation acquisition unit and the position-and-orientation of the target object acquired by the target object position-and-orientation acquisition unit.

Further features of the present invention will become apparent from the following description of exemplary embodiments with reference to the attached drawings.

### BRIEF DESCRIPTION OF THE DRAWINGS

FIG. 1 is a block diagram illustrating a configuration of an information processing apparatus according to a first exemplary embodiment.

FIG. 2 is a flowchart illustrating processing according to the first exemplary embodiment.

FIG. 3 is a diagram illustrating a geometric relationship between respective coordinates according to the first exemplary embodiment.

FIG. 4 is a flowchart illustrating gripping position-and-orientation teaching processing for a work according to a variation example 1-1.

FIG. 5 is a block diagram illustrating a configuration of an information processing apparatus according to a second exemplary embodiment.

FIGS. 6A to 6C are diagrams illustrating geometric relationships between respective coordinates according to the second exemplary embodiment.

FIG. 7 is a flowchart illustrating processing according to the second exemplary embodiment.

FIG. 8 is a block diagram illustrating an example of a hardware configuration of the information processing apparatus according to the exemplary embodiments of the present invention.

### DESCRIPTION OF THE EMBODIMENTS

Hereinafter, exemplary embodiments of the present invention will be described with reference to appended drawings. Each of the exemplary embodiments described below is one example specifically embodying an aspect of the present invention, which also serves as one of the specific exemplary embodiments of the configuration described in a scope of appended claims.

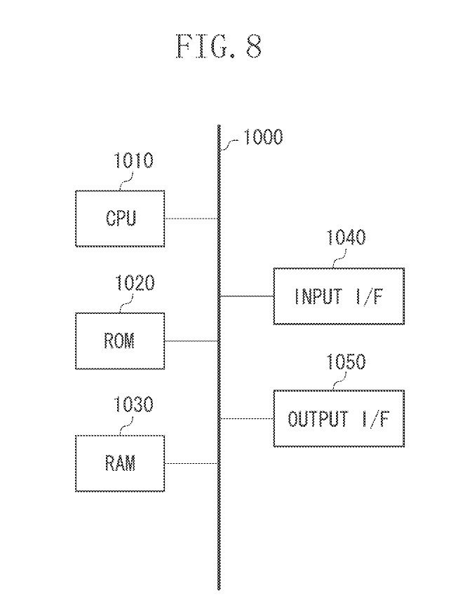

In order to describe each of the exemplary embodiments according to the present invention, a hardware configuration mounted on an information processing apparatus described in each of the exemplary embodiments will be described with reference to FIG. 8.

FIG. 8 is a block diagram illustrating a hardware configuration of an information processing apparatus 1 according to the exemplary embodiments. In FIG. 8, a central processing unit (CPU) 1010 generally controls respective devices connected thereto via a bus 1000. The CPU 1010 reads and executes processing steps or programs stored in a read only memory (ROM) 1020. Various processing programs and device drivers including an operating system (OS) relating to the present exemplary embodiments are stored in the ROM 1020 and executed by the CPU 1010 as appropriate by temporarily being stored in a random access memory (RAM) 1030. Further, an input interface (I/F) 1040 receives data from an external device such as an imaging device or an operation device in a form of an input signal that can be processed by the information processing apparatus 1. Furthermore, an output I/F 1050 outputs data to an external device such as a display device in a form of an output signal that can be processed by the display device.

In a first exemplary embodiment, in a state where a work is stably gripped with a robot hand attached to a leading end of a robot arm, a relative position-and-orientation of the robot hand and the work in a gripped state are acquired by measuring the work and recognizing the position-and-orientation thereof. In this method, because the position-and-orientations of the work and the robot hand are acquired after the work has been gripped by the robot hand, changes in the position-and-orientation of the work which may occur at the time of acquiring the position-and-orientations of the work and the robot hand can be prevented. Further, because recognition of the work is executed after confirming the state where the work has been gripped stably, the user can teach a position-and-orientation which enables the robot hand to reliably grip the work. Therefore, the user can execute an operation for teaching the gripping position-and-orientation stably and efficiently.

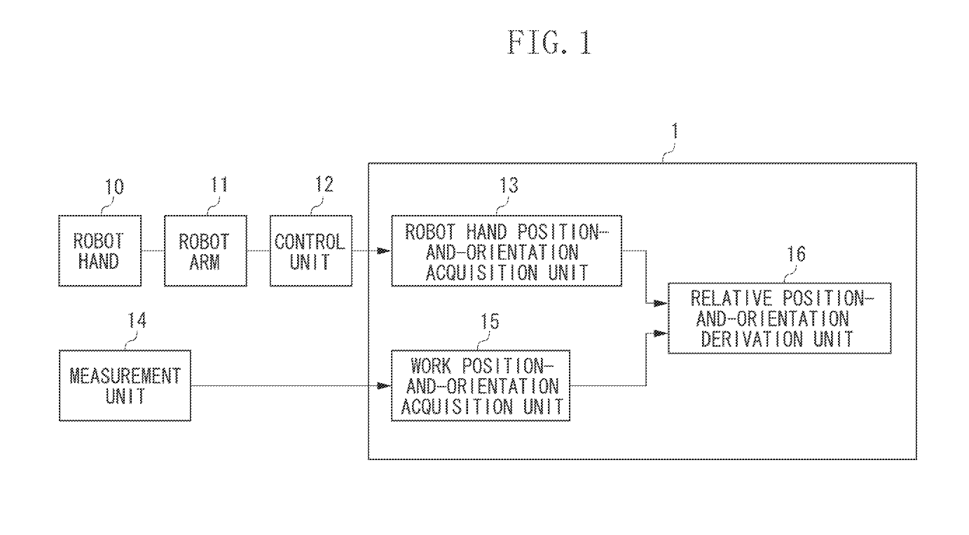

FIG. 1 is a block diagram illustrating a configuration of the information processing apparatus 1 according to the present exemplary embodiment. As illustrated in FIG. 1, the information processing apparatus 1 is configured of a robot hand position-and-orientation acquisition unit 13, a work position-and-orientation acquisition unit 15, and a relative position-and-orientation derivation unit 16, and is connected to a robot hand 10, a robot arm 11, a control unit 12, and a measurement unit 14. Hereinafter, each of the above units will be described. In the present exemplary embodiment, the robot hand 10, the robot arm 11, the control unit 12, and the measurement unit 14 are described as external devices. However, any or all of these elements may be integrally configured and included as a constituent element of the information processing apparatus 1.

Each function unit of the information processing apparatus 1 is realized by the CPU 1010 executing processing according to each of the flowcharts described below by loading a program stored in the ROM 1020 onto the RAM 1030. Further, for example, in a case where hardware is used as a substitute for the software processing executed by the CPU 1010, a calculation unit and a circuit corresponding to the processing of each function unit described below may be configured as the hardware units.

The robot hand 10 is an end effector attached to a flange at the leading end of the robot arm 11, configured to execute a grip operation of the work. For example, a magnetic type or a sticking type robot hand which grips the work by pressing the hand against a planar portion of the work, or a gripper type robot hand which opens and closes a plurality of fingers (i.e., two-finger or three-finger) to pinch and grip the work from an inside or an outside thereof may be employed as the robot hand 10. In other words, the robot hand 10 functions as a holding unit for holding the work. Any end effector including a grip mechanism attachable to the robot arm 11 may be employed as the robot hand 10. Hereinafter, “robot hand” refers to the above-described end effector for executing the grip operation, and a reference coordinate system included in the robot hand is referred to as “robot hand coordinate system”. Further, hereinafter, the robot arm 11 may be simply referred to as “robot” whereas the robot hand 10 may be simply referred to as “hand”.

As described below, the operations of the robot arm 11 having the flange at the leading end portion thereof is controlled by the control unit 12. As described above, the robot hand 10 is attached to the flange at the leading end portion of the robot arm 11. Further, in the present exemplary embodiment, a coordinate system which takes a reference position of the robot arm 11 as an origin is referred to as a robot coordinate system.

The control unit 12 controls the operations of the robot arm 11. The control unit 12 stores parameters representing the position-and-orientation set to the center of the flange at the leading end of the robot arm 11. In other words, the control unit 12 controls the robot hand 10 attached to the flange at the leading end portion of the robot arm 11 by controlling the operation of the robot arm 11. For example, by employing a method discussed in Japanese Patent Application Laid-Open No. 61-133409, processing for acquiring the relative position-and-orientation of the coordinate system set to the center of the flange and the robot hand coordinate system set to the center of the robot hand 10 is executed in advance. Then, the control unit 12 outputs the parameters representing the position-and-orientation of the robot hand coordinate system (i.e., the parameters representing the position-and-orientation of the robot hand 10) to the robot hand position-and-orientation acquisition unit 13 described below. In addition, the user can access the control unit 12 by operating a teaching pendant, a mouse, or a keyboard. In such a manner, the user can control and operate the robot arm 11 in an arbitrary position-and-orientation desired by the user. Further, in addition to controlling the operation of the robot arm 11, the control unit 12 also controls the robot hand 10 to grip or release the work. In addition, the control unit 12 may control the operation of the robot hand 10 separately from the operation of the robot arm 11.

The robot hand position-and-orientation acquisition unit 13 acquires parameters representing the position-and-orientation of the robot hand 10 in the robot coordinate system from the control unit 12.

The measurement unit 14 acquires measurement information required to recognize the position-and-orientation of the work (i.e., acquisition of measurement information). For example, a camera for capturing a two-dimensional image or a distance sensor for capturing a distance image in which each pixel thereof includes depth information may be employed as the measurement unit 14. A distance sensor which uses a camera to capture laser light or slit light radiated and reflected on a target object to measure a distance based on a triangular method, a time-of-flight type distance sensor which uses the time-of-flight of light, or a distance sensor which calculates a distance from an image captured by a stereo camera based on a triangulation method may be employed as the measurement unit 14. In addition, any sensor capable of acquiring the information required to recognize the three-dimensional position-and-orientation of the work can be employed without departing from the essential characteristics of the present invention. The measurement information acquired by the measurement unit 14 is input to the work position-and-orientation acquisition unit 15. Hereinafter, a coordinate system set to the measurement unit 14 is referred to as a sensor coordinate system (i.e., measurement coordinate system). In the present exemplary embodiment, a geometric relationship between the sensor and the robot is fixed, and the relative position-and-orientation of the robot and the measurement unit is acquired and known by previously executing the calibration of the robot and a vision system.

The work position-and-orientation acquisition unit 15 detects the work existing in a work space of the robot arm 11 based on the information received from the measurement unit 14. Then, the work position-and-orientation acquisition unit 15 recognizes the position-and-orientation of the detected work in the sensor coordinate system (i.e., acquisition of a position-and-orientation of the target object). Herein, a distance image and a density image are acquired by the sensor. In the present exemplary embodiment, a plurality of orientations of the work is stored previously, so that the position-and-orientation of the work is derived by matching patterns of the plurality of stored orientations with the work included in the acquired image. In addition, by setting the position-and-orientation acquired from the pattern matching processing as an initial position-and-orientation, model fitting processing may be executed by using a three-dimensional model of the work. Further, pattern matching processing and model fitting processing may be executed by only using the distance image or the density image, or may be executed by using both the distance image and the density image. Furthermore, a method other than the above-described methods can be employed as long as a three-dimensional position-and-orientation of the work can be calculated by recognizing the work as a gripping target from among the stacked works.

The relative position-and-orientation derivation unit 16 derives a position-and-orientation for the robot hand 10 to approach the work based on the position-and-orientation of the robot hand 10 in the robot coordinate system and the position-and-orientation of the work in the sensor coordinate system. In other words, the relative position-and-orientation derivation unit 16 derives a relative position-and-orientation of the robot hand 10 and the work as a gripping position-and-orientation. The position-and-orientation of the robot hand 10 which enables the robot hand 10 to grip the recognized work can be calculated based on the gripping position-and-orientation and the position-and-orientation of the work recognized by the vision system.

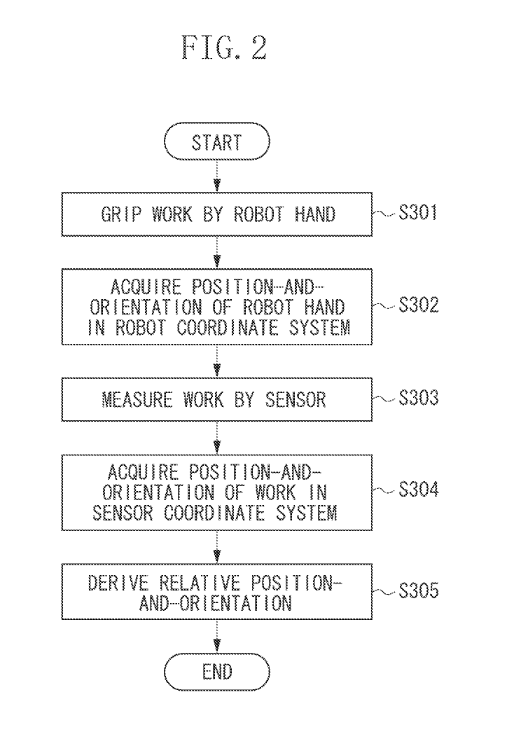

FIG. 2 is a flowchart illustrating processing for teaching a gripping position-and-orientation for gripping the work according to the present exemplary embodiment.

### <Step S301>

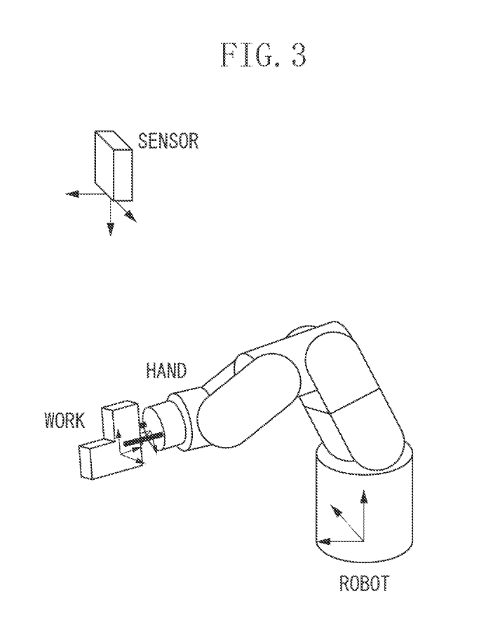

In step S301, the robot hand 10 grips the work. Specifically, the user controls the operation of the robot hand 10 via the control unit 12 to grip the work. The user moves the robot arm 11 to a position-and-orientation where the work provided within a control range of the robot arm 11 can be gripped by the robot hand 10. Then, according to the operation of the user with respect to the control unit 12, the robot hand 10 grips the work by using a grip mechanism included in the robot hand 10. Thereafter, according to the operation of the user with respect to the control unit 12, the robot arm 11 is moved to a position-and-orientation where the sensor (i.e., measurement unit 14) can easily measure the gripped work. FIG. 3 is a diagram illustrating respective coordinate systems of the sensor, the robot arm 11, the robot hand 10, and the work, and a geometric relationship between the coordinate systems at the time of executing the above operations. When the target work is measured by the sensor, the robot hand 10 has to be set to a position-and-orientation where the target work is not interrupted by the robot hand 10.

In the present exemplary embodiment, calibration of the robot and the sensor is executed prior to the processing steps illustrated in FIG. 2. In other words, six parameters representing the position-and-orientation of the robot in the sensor coordinate system are calculated and stored previously. Herein, a 3×3 rotation matrix and a three-row translation vector used to convert a coordinate system from the sensor coordinate system to the robot coordinate system are denoted as “R_{RS}” and “t_{RS}”, respectively. At this time, conversion of the coordinate system from the sensor coordinate system X_{S}=[X_{S}, Y_{S}, Z_{S}]^{T} to the robot coordinate system X_{R}=[X_{R}, Y_{R}, Z_{R}]^{T} can be expressed as follows by using a 4×4 matrix I_{RS}.

X_{R}′=T_{RS}X_{S}′ FORMULA 1

Herein, the following relationship is established.

$${X}_{R}^{′} = {[ \begin{matrix}\begin{matrix}{X}_{R} , & {Y}_{R} , & {Z}_{R} ,\end{matrix} & 1\end{matrix} ]}^{T} {X}_{S}^{′} = {[ \begin{matrix}{X}_{S} , & {Y}_{S} , & {Z}_{S} , & 1\end{matrix} ]}^{T}$$

$${T}_{RS} = [ \begin{matrix}{R}_{RS} & {t}_{RS} \\ {O}^{T} & 1\end{matrix} ]$$

When the robot hand 10 grips the work, the processing proceeds to step S302.

### <Step S302>

In step S302, the robot hand position-and-orientation acquisition unit 13 acquires the six parameters representing the position-and-orientation of the robot hand 10 in the robot coordinate system from the control unit 12. As described above, because the control unit 12 stores the parameters which represent the position-and-orientation set to the center of the flange at the leading end portion of the robot arm 11, the position-and-orientation of the robot hand 10 can be acquired from the position-and-orientation set to the center of the flange stored in the control unit 12. Therefore, the robot hand position-and-orientation acquisition unit 13 acquires the position-and-orientation of the robot hand 10 from the control unit 12.

Herein, the calibration of the robot arm 11 and the robot hand 10 is executed previously. In this way, three parameters representing the three-dimensional position of the robot hand 10 and three parameters representing the orientation of the robot hand 10 in the robot coordinate system (i.e., six parameters) can be acquired from the control unit 12. The three parameters representing the orientation are parameters which represent a rotation axis and a rotation angle. That is, an orientation of a vector expressed by the three parameters represents the rotation axis whereas a norm of the vector represents the rotation angle. However, any parameters in another representation can be employed as long as the parameters can similarly represent the orientation. For example, three parameters in Euler angle representation or four parameters in quaternion representation may be employed instead of the above-described parameters. Herein, a 3×3 rotation matrix expressed by the three parameters representing the orientation, which is used to convert the coordinate system of the orientation from the robot coordinate system to the robot hand coordinate system is denoted as “R_{HR}”, whereas a three-row translation vector expressed by the three parameters representing the position is denoted as “t_{HR}”. At this time, the conversion of the coordinate system from the robot coordinate system X_{R}=[X_{R}, Y_{R}, Z_{R}]^{T} to the robot hand coordinate system X_{H}=[X_{H}, Y_{H}, Z_{H}]^{T} can be expressed as follows by using a 4×4 matrix T_{HR}.

X_{H}′=T_{HR}X_{R}′ FORMULA 2

Herein, the following relationship is established.

$${X}_{H}^{′} = {[ \begin{matrix}\begin{matrix}{X}_{H} , & {Y}_{H} , & {Z}_{H} ,\end{matrix} & 1\end{matrix} ]}^{T} {X}_{R}^{′} = {[ \begin{matrix}{X}_{R} , & {Y}_{R} , & {Z}_{R} , & 1\end{matrix} ]}^{T}$$

$${T}_{HR} = [ \begin{matrix}{R}_{HR} & {t}_{HR} \\ {O}^{T} & 1\end{matrix} ]$$

The robot hand position-and-orientation acquisition unit 13 transmits the acquired position-and-orientation of the robot hand 10 to the relative position-and-orientation derivation unit 16.

### <Step S303>

In step S303, the measurement unit 14 acquires the measurement information for recognizing the position-and-orientation of the work. In the present exemplary embodiment, a distance image and a density image are acquired as the measurement information by an imaging device included in the measurement unit 14. In the present exemplary embodiment, although the imaging device included in the measurement unit 14 is employed, another sensor may be employed as long as the measurement information for recognizing the position-and-orientation of the work can be acquired. The measurement unit 14 transmits the acquired measurement information to the work position-and-orientation acquisition unit 15.

### <Step S304>

In step S304, the work position-and-orientation acquisition unit 15 recognizes the position-and-orientation of the work based on the measurement information acquired from the measurement unit 14. Specifically, the work position-and-orientation acquisition unit 15 calculates six parameters representing the position-and-orientation of the work in the sensor coordinate system. In the present exemplary embodiment, the parameters representing the position-and-orientation of the work are calculated by matching the pattern of the stored three-dimensional model of the work with the density image or the distance image. For example, a known method discussed in Japanese Patent Application Laid-Open No. 9-212643 can be employed in order to execute the above processing.

Then, the coordinate system of the calculated parameters is converted into the work coordinate system from the sensor coordinate system. Herein, a 3×3 rotation matrix expressed by the three parameters which represent the orientation is denoted as “R_{WS}”, whereas a three-row translation vector expressed by the three parameters which represent the position is denoted as “t_{WS}”. At this time, the conversion of the coordinate system from the sensor coordinate system X_{S}=[X_{S}, Y_{S}, Z_{S}]^{T} to the work coordinate system X_{W}=[X_{W}, Y_{W}, Z_{W}]^{T} can be expressed as follows by using a 4×4 matrix T_{WS}.

X_{W}′=T_{WS}X_{S}′ FORMULA 3

Herein, the following relationship is established.

$${X}_{W}^{′} = {[ \begin{matrix}\begin{matrix}{X}_{W} , & {Y}_{W} , & {Z}_{W} ,\end{matrix} & 1\end{matrix} ]}^{T} {X}_{S}^{′} = {[ \begin{matrix}{X}_{S} , & {Y}_{S} , & {Z}_{S} , & 1\end{matrix} ]}^{T}$$

$${T}_{WS} = [ \begin{matrix}{R}_{WS} & {t}_{WS} \\ {O}^{T} & 1\end{matrix} ]$$

The work position-and-orientation acquisition unit 15 transmits the acquired parameters representing the position-and-orientation of the work in the sensor coordinate system to the relative position-and-orientation derivation unit 16.

### <Step S305>

In step S305, the relative position-and-orientation derivation unit 16 derives six parameters representing the gripping position-and-orientation for gripping the work. In order to teach the gripping position-and-orientation of the robot hand 10, six parameters representing the position-and-orientation of the work coordinate system in the robot hand coordinate system are calculated while the work is being gripped by the robot hand 10. A 3×3 rotation matrix and a three-row translation vector expressed by the unknown six parameters, which are used to convert the coordinate system from the sensor coordinate system to the work coordinate system, are denoted as “R_{HW}” and “t_{HW}” respectively. At this time, the conversion of the coordinate system from the work coordinate system X_{W}=[X_{W}, Y_{W}, Z_{W}]^{T} to the robot hand coordinate system X_{H}=[X_{H}, Y_{H}, Z_{H}]^{T} can be expressed as follows by using a 4×4 matrix T_{HW}.

X_{H}′=T_{HW}X_{W}′ FORMULA 4

Herein, the following relationship is established.

X_{H}′=[X_{H}, Y_{H}, Z_{H}, 1]_{T} X_{W}′=[X_{W}, Y_{W}, Z_{W}, 1]^{T}

Herein, the following relationship is established by the equivalence of the coordinate conversion.

T_{HW}T_{WS}=T_{HR}T_{RS} FORMULA 5

In the formula 5, respective values for “T_{HR}”, “T_{RS}”, and “T_{WS}” can be calculated from the six parameters stored in the above-described steps S301, S302, and S303. Accordingly, the value for “T_{HW}” can be acquired from the following formula.

T_{HW}=T_{HR}T_{RS}(T_{WS})⁻¹ FORMULA 6

Further, six parameters representing the relative position-and-orientation of the work coordinate system and the robot hand coordinate system is acquired from the calculated value T_{HW}. Specifically, three parameters representing a rotation axis and a rotation angle, in which the orientation of the three-row translation vector represents the rotation axis whereas a norm of the three-row translation vector represents the rotation angle, are calculated as the parameters representing the orientation from the 3×3 rotation matrix R_{HW} which constitutes the 4×4 matrix T_{HW}. Further, three parameters expressing the three-row translation vector t_{HW} are calculated as the parameters representing the position. The six parameters calculated in the above processing are stored as the gripping position-and-orientation.

In this way, with respect to the work in an arbitrary three-dimensional position-and-orientation recognized by the vision system, the position-and-orientation of the robot hand 10 which enables the robot hand 10 to grip that work can be calculated. Specifically, when the position-and-orientation of the work recognized by the vision system is denoted as T_{WS}′, the position-and-orientation T_{HR}′ of the robot hand 10 which enables the robot hand 10 to grip the work can be calculated by the following formula by using the 4×4 matrix T_{HW} expressed by the six parameters representing the gripping position-and-orientation.

T_{HR}′=T_{HW}T_{WS}′(T_{RS})⁻¹ FORMULA 7

As described above, in the present exemplary embodiment, in a state where the work is stably gripped with the robot hand 10 attached to the leading end portion of the robot arm 11, a relative position-and-orientation of the robot hand 10 and the work in a gripped state is acquired by measuring the work and recognizing the position-and-orientation thereof. In the above-described method, because the position-and-orientations of the work and the robot hand 10 are acquired after the work has been gripped by the robot hand 10, changes in the position-and-orientation of the work which may occur at the time of acquiring the position-and-orientations of the work and the robot hand 10 can be prevented. Further, because recognition of the work is executed after confirming the state where the work has been gripped stably, the user can teach a position-and-orientation which enables the robot hand 10 to reliably grip the work. Therefore, the user can execute an operation for teaching the gripping position-and-orientation stably and efficiently.

### VARIATION EXAMPLE 1-1

In the first exemplary embodiment, in a state where the work is gripped by the robot hand 10, the three-dimensional position-and-orientation of the work has been recognized and the position-and-orientation of the robot hand 10 has been acquired. Then, the relative position-and-orientation of the robot hand 10 and the work have been calculated based on the recognized three-dimensional position-and-orientation of the work and the acquired position-and-orientation of the robot hand 10. On the contrary, in a variation example 1-1, recognition of the position-and-orientation of the work and acquisition of the position-and-orientation of the robot hand 10 are executed for a plurality of times by changing the position-and-orientation of the robot hand 10 while maintaining the gripped state of the work. Then, the gripping position-and-orientation is calculated from a plurality of correspondence relationships therebetween in order to teach the gripping position-and-orientation with higher precision. A configuration of the apparatus in the variation example 1-1 is the same as that described in the first exemplary embodiment, and thus the description thereof will be omitted.

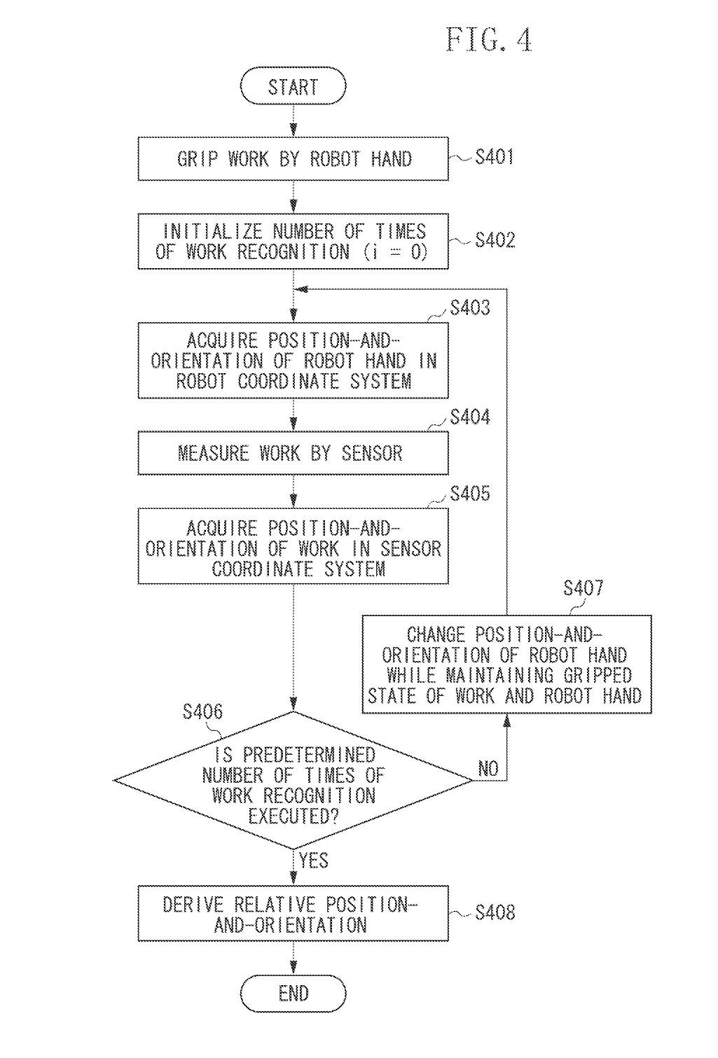

FIG. 4 is a flowchart illustrating a processing procedure for teaching a gripping position-and-orientation for gripping the work according to the variation example 1-1.

### <Step S401>

The processing in step S401 is the same as the processing executed in step S301, and thus the description thereof will be omitted.

### <Step S402>

In step S402, the work position-and-orientation acquisition unit 15 sets and initializes a counter value i for counting the number of times of recognition of the three-dimensional position-and-orientation of the work to 0 (i=0).

### <Step S403>

In step S403, the robot hand position-and-orientation acquisition unit 13 executes the same processing as in step S302 to acquire and store the six parameters representing the position-and-orientation of the robot hand 10 in the robot coordinate system from the control unit (controller) 12. At this time, the counter value i at the time of executing the above processing is also stored together with the six parameters. Herein, a 4×4 matrix expressed by the stored six parameters, which is used to convert the coordinate system from the robot coordinate system X_{R}=[X_{R}, Y_{R}, Z_{R}]^{T} to the robot hand coordinate system X_{H}=[X_{H}, Y_{H}, Z_{H}]^{T}, is denoted as “T_{HR}_{_{—}}ᵢ”.

### <Step S404>

The processing in step S404 is the same as the processing executed in step S303, and thus the description thereof will be omitted.

### <Step S405>

In step S405, the work position-and-orientation acquisition unit 15 executes the same processing as in step S304 to calculate the six parameters representing the position-and-orientation of the work in the sensor coordinate system. At this time, the counter value i at the time of executing the above processing is also stored together with the six parameters. Herein, a 4×4 matrix expressed by the stored six parameters, which is used to convert the coordinate system from the sensor coordinate system X_{S}=[X_{S}, Y_{S}, Z_{S}]^{T} to the work coordinate system X_{W}=[X_{W}, Y_{W}, Z_{W}]^{T}, is denoted as “T_{WS}_{_{—}}ᵢ”.

### <Step S406>

In step S406, the work position-and-orientation acquisition unit 15 updates the counter value i to “i=i+1”. In a case where a predetermined number of times N (e.g., N=5) satisfies the condition i<N (NO in step S406), the processing proceeds to step S407. In a case where the predetermined number of times N does not satisfy the condition i<N (YES in step S406), the processing proceeds to step S408.

### <Step S407>

In step S407, the control unit 12 stops moving the robot hand 10 after changing the position-and-orientation of the robot hand 10 while maintaining a gripped state of the work by the robot hand 10 (i.e., while fixing the relative position-and-orientation of the robot hand 10 and the work). At this time, in order to teach the gripping position-and-orientation by averaging the error in the orientation of the robot hand 10 caused by deviation of the robot coordinate system and the error in the result of the work recognition caused by deviation of the sensor coordinate system, the position-and-orientation of the robot hand 10 is desirably set to a position-and-orientation different from the previous position-and-orientation as much as possible. After executing the processing in step S407, the processing returns to step S403. The processing described in step S407 may be executed to automatically change the position-and-orientation of the robot hand 10 within a predetermined range, or may be executed by the user to change as appropriate.

### <Step S408>

In step S408, the relative position-and-orientation derivation unit 16 acquires N-pieces of correspondence relationships between the 4×4 matrices T_{HR}_{_{—}}ᵢ and T_{WS}_{_{—}}ᵢ (i=0 to N−1) by executing the measurement processing for N-times. The six parameters representing the gripping position-and-orientation for gripping the work are calculated by using these correspondence relationships.

When a 4×4 matrix which represents the conversion of the coordinate system from the work coordinate system X_{W}=[X_{W}, Y_{W}, Z_{W}]^{T} to the robot hand coordinate system X_{H}=[X_{H}, Y_{H}, Z_{H}]^{T} is denoted as “T_{HW}”, the following relationship is established.

T_{HW}[T_{SW}_{_{—}}₁ T_{WS}_{_{—}}₂ . . . T_{WS}_{_{—}}_{N}]^{T}=[T_{HR}_{_{—}}₁T_{RS} T_{HR}_{_{—}}₂T_{RS} . . . T_{HR}_{_{—}}_{N}T_{RS}]^{T} FORMULA 8

Accordingly, a value for the 4×4 matrix T_{HW} can be acquired by the following formula.

T_{HW}=T_{HS}′(T_{WS}′)⁺ FORMULA 9

Herein, the following relationship is established.

T_{HS}′=[T_{HR}_{_{—}}₁T_{RS} T_{HR}_{_{—}}₂T_{RS} . . . T_{HR}_{_{—}}_{N}T_{RS}]^{T} T_{WS}′=[T_{WS}_{_{—}}₁ T_{WS}_{_{—}}₂ . . . T_{WS}_{_{—}}_{N}]

In addition, (T_{WS}′)⁺ is a pseudo inverse matrix of T_{WS}′. Similar to the first exemplary embodiment, the 4×4 matrix T_{HW} calculated above is configured of the 3×3 rotation matrix R_{HW} for converting the coordinate system of the orientation from the sensor coordinate system to the work coordinate system, and a three-row translation vector t_{HW} for converting the coordinate system of the position from the work coordinate system to the robot hand coordinate system. Therefore, the six parameters representing the position-and-orientation can be acquired by the same method. The six parameters calculated as the above are stored as the gripping position-and-orientation in order to execute the teaching operation of the gripping position-and-orientation. As described above, in the present exemplary embodiment, a plurality of sets of the position-and-orientation of the robot hand 10 and the position-and-orientation of the work in a gripped state is acquired and used. Therefore, the 4×4 matrix T_{HW}, which expresses the conversion of the coordinate system, can be derived with higher precision while reducing the influence of an accidental error arising in the position-and-orientation of the work.

A nonlinear optimization method such as the Gauss-Newton method may be applied to the six parameters representing the gripping position-and-orientation calculated by the above-described method. In such a case, a difference value in respective six parameters representing the position-and-orientation of each work acquired in step S403, the position-and-orientation of the robot hand 10 calculated based on the gripping position-and-orientation acquired in step S408, and the position-and-orientation of the robot hand 10 acquired in step S404 is calculated. Then, the difference value is expressed by linear approximation as a function of minimal change of the gripping position-and-orientation, and a linear equation that makes the difference value be 0 is established. The minimal change of the gripping position-and-orientation is acquired by solving the linear equation as simultaneous equations in order to correct the position and the orientation thereof. In addition, the nonlinear optimization method is not limited to the Gauss-Newton method. For example, the nonlinear optimization may be executed by a more robust calculation method such as the Levenberg-Marquardt method or a more simple calculation method such as a steepest descent method. Further, other nonlinear optimization methods such as a conjugate gradient method or an incomplete Cholesky conjugate gradient (ICCG) method may be also employed.

As described above, in the variation example 1-1, recognition of the three-dimensional position-and-orientation of the work and acquisition of the position-and-orientation of the robot hand 10 are executed for a plurality of times by changing the three-dimensional position-and-orientation of the robot hand 10 while maintaining the gripped state of the work. Then, the gripping position-and-orientation is calculated with higher precision by using a plurality of correspondence relationships. Further, in order to calculate the gripping position-and-orientation with higher precision, the six parameters representing the gripping position-and-orientation may be acquired and the parameters representing N-pieces of the position-and-orientations are averaged by the same method as in the first exemplary embodiment by using the correspondence relationships between the position-and-orientations of the robot hand 10 and the work acquired from N-times of the measurement processing. However, as for the three parameters representing the orientation, a correct orientation for interpolating N-pieces of the orientations cannot be acquired if the parameter values are simply averaged. Therefore, N-pieces of the orientations converted into and represented by quaternions are mapped onto a logarithmic space in order to acquire a weighted average value. Thereafter, an average of the orientations can be acquired by executing exponential mapping to return the acquired value to quaternions. Furthermore, in a case where N=2, the averaged orientation may be acquired by executing spherical linear interpolation of two orientations after the two orientations are respectively converted into and represented by quaternions.

According to a method described in a second exemplary embodiment, in a case where the work has a shape rotationally symmetrical to a certain axis, an axis for specifying the rotational symmetry of the work (hereinafter, referred to as “symmetrical axis”) is calculated in addition to the operation for teaching the gripping position-and-orientation.

Generally, in a vision system, six parameters configured of a three-dimensional position and a triaxial orientation are calculated in order to recognize a work stacked in an arbitrary position-and-orientation. In a case where the target work of the vision system has a rotationally symmetrical shape, observation information will be the same for a plurality of the orientations when the work is rotated about a symmetrical axis. Because the vision system cannot distinguish between these orientations, a plurality of solutions is output with respect to the work in a certain orientation. Accordingly, in a case where the robot hand approaches and grips the work based on the taught gripping position-and-orientation, the position-and-orientation of the robot hand depends on the three-dimensional position-and-orientation recognized by the vision system. As a result, even if the robot hand can actually grip the work in another position-and-orientation by rotating about the symmetrical axis of the work, the robot hand cannot select another position-and-orientation.

Therefore, the symmetrical axis of the work is previously estimated in order to make another position-and-orientation selectable as a candidate of the gripping position-and-orientation by using the symmetrical axis of the work in addition to the taught gripping position-and-orientation. More specifically, the symmetrical axis is calculated based on the indefinite components of the orientation around the symmetrical axis when the work is recognized by the vision system.

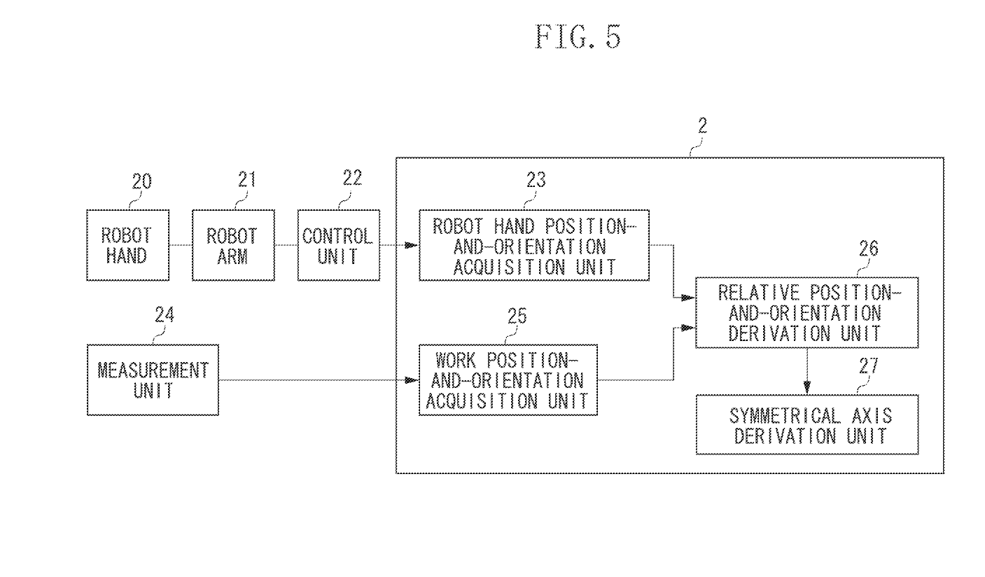

FIG. 5 is a diagram illustrating an apparatus configuration of an information processing apparatus 2 according to the present exemplary embodiment. Similar to the first exemplary embodiment, the information processing apparatus 2 according to the present exemplary embodiment is configured of a robot hand position-and-orientation acquisition unit 23, a work position-and-orientation acquisition unit 25, a relative position-and-orientation derivation unit 26, and a symmetrical axis derivation unit 27, and is connected to a robot hand 20, a robot arm 21, a control unit 22, and a measurement unit 24. Thus, description will be omitted with respect to the units which are similar to the robot hand 10, the control unit 12, the robot hand position-and-orientation acquisition unit 13, the measurement unit 14, the work position-and-orientation acquisition unit 15, and the relative position-and-orientation derivation unit 16 illustrated in FIG. 1. Therefore, only the symmetrical axis derivation unit 27 will be described below.

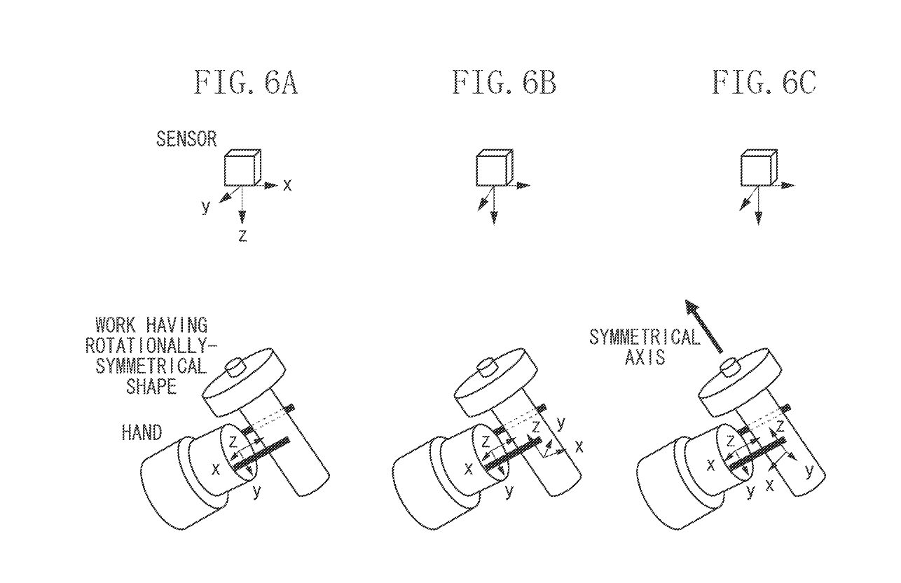

The symmetrical axis derivation unit 27 derives the symmetrical axis of the work based on the relative position-and-orientation derived by the relative position-and-orientation derivation unit 26. The symmetrical axis derivation unit 27 will be further described with reference to FIGS. 6A, 6B, and 6C.

FIG. 6A is a diagram illustrating an example of calculating the gripping position-and-orientation with respect to the work having a rotationally symmetrical shape by employing a similar method to that in the first exemplary embodiment. When the work position-and-orientation acquisition unit 25 calculates the position-and-orientation of the work having a rotationally-symmetrical shape, orientation components of the work around the rotational axis thereof become indefinite. Accordingly, the work position-and-orientation acquisition unit 25 may calculate the position-and-orientation of the work illustrated in FIG. 6B, or may calculate the position-and-orientation illustrated in FIG. 6C. Therefore, the gripping position-and-orientations respectively calculated based on the recognition results of the works illustrated in FIGS. 6A and 6B are the position-and-orientations in which the robot hand is rotated about the symmetrical axis of the work. Therefore, the position-and-orientation of the work and the gripping position-and-orientation are calculated twice without changing the gripped state of the robot hand and the work. Then, based on the relative position-and-orientation of the calculated two gripping position-and-orientations, the symmetrical axis is calculated to make the calculated position-and-orientation of the work become indefinite.

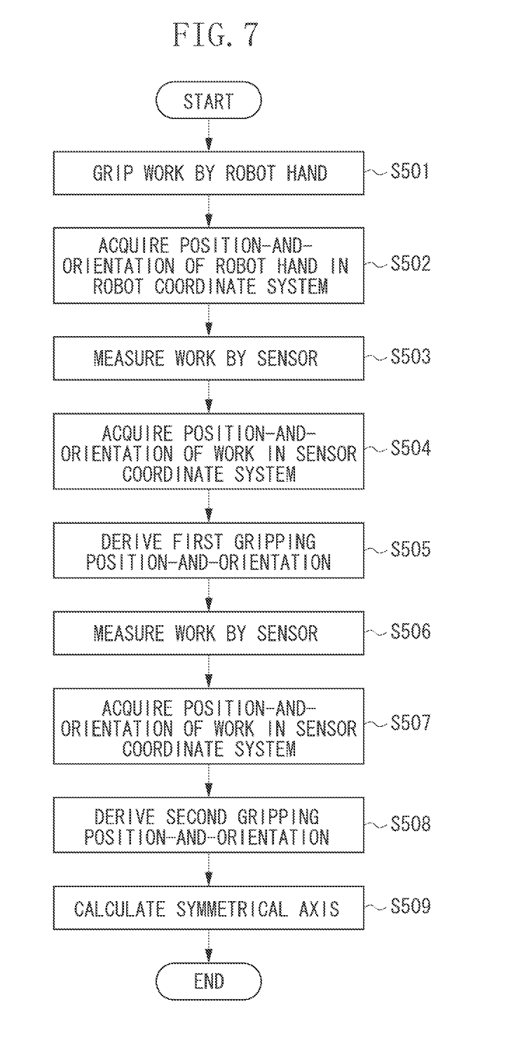

FIG. 7 is a flowchart illustrating basic processing according to the present exemplary embodiment. The processing in steps S501 to S504 is similar to the processing in steps S301 to S304 of FIG. 2. Further, the processing in steps S506 and S507 is the same as the processing in steps S303 and S304 of FIG. 2. Therefore, description thereof will be omitted. Accordingly, only the processing in steps S505, S508, and S509 will be described below.

### <Step S505>

In step S505, the relative position-and-orientation derivation unit 26 calculates six parameters representing a first gripping position-and-orientation by executing similar processing to that described in step S305. With respect to the work in a gripped state illustrated in FIG. 6A, a position-and-orientation of the work illustrated in FIG. 6B is acquired as a result of derivation, so that the six parameters representing the first gripping position-and-orientation are calculated based on that result. A 4×4 matrix expressed by the calculated six parameters is referred to as “T_{HW}_{_{—}}_{BASE}”. The relative position-and-orientation derivation unit 26 transmits the derived parameters representing the first gripping position-and-orientation to the symmetrical axis derivation unit 27.

### <Step S508>

In step S508, the relative position-and-orientation derivation unit 26 calculates six parameters representing a second gripping position-and-orientation by executing similar processing to that in step S505. Herein, with respect to the work in a gripped state illustrated in FIG. 6A, a position-and-orientation of the work illustrated in FIG. 6C is acquired as a result of derivation, so that the six parameters representing the second gripping position-and-orientation are calculated based on that result. Herein, a 4×4 matrix expressed by the calculated six parameters is referred to as “T_{HW}_{_{—}}_{REF}”. The relative position-and-orientation derivation unit 26 transmits the derived parameters representing the second gripping position-and-orientation to the symmetrical axis derivation unit 27.

### <Step S509>

In step S509, the symmetrical axis derivation unit 27 derives (calculates) the symmetrical axis of the work from the two 4×4 matrices, T_{HW}_{_{—}}_{BASE} and T_{HW}_{_{—}}_{REF}. Specifically, based on the symmetrical axis of the work as an acquisition target, the symmetrical axis is calculated so as to make the first gripping position-and-orientation matches the second gripping position-and-orientation by rotating the robot hand. First, a 3×3 rotation matrix and a three-row translation vector used to execute the conversion between the first and the second gripping position-and-orientations T_{HW}_{_{—}}_{BASE} and T_{HW}_{_{—}}_{REF} are denoted as R′ and t′ respectively. At this time, the conversion between the first and the second gripping position-and-orientations can be expressed as follows by using a 4×4 matrix T′.

$${T}_{HW\_REF} = \begin{matrix}{T}^{′} & {T}_{HW\_BASE}\end{matrix} \\ {T}^{′} = [ \begin{matrix}{R}^{′} & {t}^{′} \\ {O}^{T} & 1\end{matrix} ] \qquad FORMULA 10$$

Accordingly, a value for T′ can be acquired by the following formula.

T′=T_{HW}_{_{—}}_{REF}(T_{HW}_{_{—}}_{BASE})⁻¹ FORMULA 11

Further, the 3×3 rotation matrix R′ in the value T′ calculated by the above formula 11 is expressed as follows.

$${R}^{′} = [ \begin{matrix}{r}_{11} & {r}_{12} & {r}_{31} \\ {r}_{21} & {r}_{22} & {r}_{32} \\ {r}_{31} & {r}_{23} & {r}_{33}\end{matrix} ]$$

At this time, the symmetrical axis as an acquisition target can be expressed by a vector t′ which represents translation components from the original point of the work coordinate system to the central position of the symmetrical axis and a vector Axis which represents the orientation of the symmetrical axis. Further, a value for the vector Axis can be acquired from the following formula 12.

Axis=[r₃₂−r₂₃, r₁₃−r₃₁, r₂₁−r₁₂]^{T} FORMULA 12

In addition, the vector Axis representing the orientation of the symmetrical axis may be acquired by another method. For example, the three parameters representing each of the orientations of the first and the second gripping position-and-orientations T_{HW}_{_{—}}_{BASE} and T_{HW}_{_{—}}_{REF} are converted into and represented by quaternions, and parameters in quaternions used to execute the conversion of the two orientations are acquired. Thereafter, the quaternions are converted so as to represent a rotation axis and a rotation angle, and thus an axis acquired therefrom can be taken as the symmetrical axis.

In the present exemplary embodiment, the six parameters representing the first gripping position-and-orientation are taken as the final gripping position-and-orientation, and the vectors t′ and Axis representing the axis calculated from the formula 12 are stored together with the gripping position-and-orientation. In addition, the second gripping position-and-orientation may be stored as the final gripping position-and-orientation.

In this way, with respect to the recognized work in an arbitrary three-dimensional position-and-orientation, the position-and-orientation of the robot hand which enables the robot hand to grip the work can be calculated, and a position-and-orientation acquired by rotating the robot hand about the symmetrical axis can be also selected as a candidate of the gripping position-and-orientation. Specifically, when the position-and-orientation of the work recognized by the vision system is denoted as T_{WS}′, the position-and-orientation T_{HR}′ of the robot hand which enables the robot hand to grip the work can be calculated by the following formula by using the 4×4 matrix T_{HW}_{_{—}}_{BASE}, and the vectors Axis and t′ expressed by the stored six parameters.

T_{HR}′=TT_{HW}_{_{—}}_{BASE}T_{WS}′(T_{RS})⁻¹ FORMULA 13

Herein, the following relationship is established.

In addition, “R” is a rotation matrix for performing a rotation about the symmetrical axis having the orientation expressed by the vector Axis by an arbitrary angle.

As described above, according to the present exemplary embodiment, in a case where the work has a rotationally-symmetrical shape with respect to a certain axis, a symmetrical axis of the work is also calculated in addition to teaching the gripping position-and-orientation. With this method, in addition to the position-and-orientation calculated based on the taught gripping position-and-orientation, a position-and-orientation acquired by rotating the robot hand about the symmetrical axis of the work can be also used as a candidate of the gripping position-and-orientation. Therefore, the work can be gripped with higher possibility. In other word, even in a case where the position-and-orientation of the hand derived from the position-and-orientation of the work recognized from among the stacked works goes beyond the operable range of the robot arm, or corresponds to an irregular position-and-orientation, the position-and-orientation of the hand can be newly derived around the symmetrical axis.

In the processing of step S509, when a rotation angle expressed by the calculated rotation matrix R′ is denoted as “φ”, it is assumed that the axis may not be calculated stably if the rotation angle φ is extremely small (e.g., φ=0.001°). In such a case, the processing in steps S506 to S508 may be executed repeatedly until the rotation angle φ has a large value. Further, in the present exemplary embodiment, the symmetrical axis of the work has been calculated based on the two gripping position-and-orientations calculated in steps S505 and S508, respectively. However, the symmetrical axis of the work can be calculated based on a result of the work recognition used for the calculation of the respective gripping position-and-orientations. Further, the gripping position-and-orientation and the symmetrical axis can be calculated with higher precision by measuring the work for a plurality of times as described in the variation example 1-1.

In the first and the second exemplary embodiments, only the gripping position-and-orientation has been calculated while a position-and-orientation of the robot hand has been treated as a known value by executing the calibration of the robot and the sensor in advance. On the contrary, in a third exemplary embodiment, recognition of the three-dimensional position-and-orientation of the work and acquisition of the position-and-orientation of the robot hand are executed by changing the position-and-orientation of the robot hand for a plurality of times while maintaining a gripped state of the work. Then, by using a plurality of correspondence relationships, the position-and-orientations of the robot and the sensor are estimated while calculating the gripping position-and-orientation. In the first exemplary embodiment, the calibration of the sensor and the robot, and the calibration of the robot and the robot hand have to be executed previously and separately. However, in the present exemplary embodiment, it is not necessary to execute the above-described calibrations, and thus the operation can be executed more efficiently.

In addition, an apparatus configuration of the present exemplary embodiment is the same as that of the first exemplary embodiment, and thus description thereof will be omitted. Further, a basic processing flow of the present exemplary embodiment is approximately the same as that of the variation example 1-1 illustrated in FIG. 4. Therefore, hereinafter, only steps S401 and S408, which are different from the processing described in the variation example 1-1, will be described.

### <Step S401>

In step S401, similar to the processing in step S301, the control unit 12 moves the robot arm 11 to a position-and-orientation which enables the robot arm 11 to grip the work provided within a control range of the robot arm 11. Then, the robot arm 11 grips the work by using the grip mechanism of the robot hand 10. However, the present exemplary embodiment is different in that the six parameters representing the position-and-orientation of the robot arm 11 in the sensor coordinate system are unknown. In other words, the 4×4 matrix T_{RS} which represents the conversion of the coordinate system from the sensor coordinate system X_{S}=[X_{S}, Y_{S}, Z_{S}]^{T} to the robot coordinate system X_{R}=[X_{R}, Y_{R}, Z_{R}]^{T} is unknown.

### <Step S408>

In step S408, the six parameters representing the gripping position-and-orientation for gripping the work are derived by using N-pieces of correspondence relationships between the 4×4 matrices T_{HR}_{_{—}}ᵢ and T_{WS}_{_{—}}ᵢ (i=0 to N−1) acquired from N-times of the measurement processing. Further, the six parameters representing the position-and-orientation of the robot 11 in the sensor coordinate system are also calculated. Specifically, with respect to the correspondence relationships acquired from the measurement processing, values for T_{HW} and T_{RS} which satisfy the following relationship are acquired.

T_{HR}_{_{—}}ᵢT_{RS}=T_{HW}T_{WS}_{_{—}}ᵢ FORMULA 14

The gripping position-and-orientation for gripping the work and the relative position-and-orientation of the sensor and the robot 11 can be acquired by solving the equation described in the formula 14. For example, the equation described in the formula 14 can be solved by the method described in the following non-patent literature, F. Dornaika, “Simultaneous robot-world and hand-eye calibration,” IEEE Robotics and Automation Society, vol. 14, issue 4, pp. 617-622, 1998.

In this method, a tool attached to a robot hand is placed in a plurality of position-and-orientations in a three-dimensional space, and three-dimensional position-and-orientations are detected by measuring the position-and-orientations by a camera. Then, a relative position-and-orientation of the robot and the sensor, and a relative position-and-orientation of the robot hand and the tool are calculated by using a plurality of correspondences. Specifically, the relative position-and-orientation of a tool coordinate system and a sensor coordinate system is denoted as A (known), whereas the relative position-and-orientation of a robot hand coordinate system and a reference coordinate system is denoted as B (known). Further, the relative position-and-orientation of the robot hand coordinate system and the tool coordinate system is denoted as X (unknown), and the relative position-and-orientation of the reference coordinate system and a camera coordinate system is denoted as Z (unknown). At this time, the unknown parameters X and Z are acquired simultaneously by solving the following equation by using a plurality of correspondences between A and B.

AX=ZB FORMULA 15

The equation described in the formula 14 can be replaced with an equation similar to the formula 15 by respectively denoting the known parameters T_{HR}_{_{—}}ᵢ and T_{WS}_{_{—}}ᵢ as A and B, and the unknown parameters T_{RS} and T_{HW} as X and Z. Accordingly, the unknown parameters T_{HW} and T_{RS} can be acquired by the same solving method.

As with the case of the first exemplary embodiment, the six parameters expressing a 3×3 rotation matrix and a three-row translation vector used to convert the coordinate system from the work coordinate system to the robot hand coordinate system are acquired from the parameter T_{HW} calculated from the above equation. Further, the six parameters representing a 3×3 rotation matrix and a three-row translation vector used to convert the coordinate system from the sensor coordinate system to the robot coordinate system are acquired from the parameter T_{RS} calculated similarly as the above.

As described above, in the present exemplary embodiment, the three-dimensional position-and-orientation of the work is recognized and the position-and-orientation of the robot hand is acquired by changing the position-and-orientation of the robot hand for a plurality of times while maintaining the gripped state of the work. The method of estimating the position-and-orientations of the robot and the sensor while calculating the gripping position-and-orientation by using a plurality of the correspondence relationships is described above. With the above-describe method, it is not necessary to execute the calibration of the sensor and the robot and the calibration of the robot and the robot hand, which have to be executed previously and separately in the first exemplary embodiment. Therefore, the operation for teaching the gripping position-and-orientation can be executed more efficiently.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-078710 filed Apr. 7, 2014, which is hereby incorporated by reference herein in its entirety.

What is claimed is:

1. An information processing apparatus comprising:
a position-and-orientation acquisition unit configured to acquire a position-and-orientation of a holding unit in a state of holding a target object;
a target object position-and-orientation acquisition unit configured to acquire a position-and-orientation of the target object in a state of being held by the holding unit; and
a derivation unit configured to derive a relative position-and-orientation of the holding unit and the target object based on the position-and-orientation of the holding unit acquired by the position-and-orientation acquisition unit and the position-and-orientation of the target object acquired by the target object position-and-orientation acquisition unit.

2. The information processing apparatus according to claim 1, further comprising:
a measurement unit configured to acquire measurement information of the target object in a state of being held by the holding unit;
wherein the target object position-and-orientation acquisition unit acquires the position-and-orientation of the target object based on the acquired measurement information.

3. The information processing apparatus according to claim 2,
wherein the measurement unit acquires an image of the target object as measurement information, and
wherein the target object position-and-orientation acquisition unit acquires the position-and-orientation of the target object by associating the target object in the image acquired as the measurement information with a model representing a shape of the target object.

4. The information processing apparatus according to claim 3,
wherein, based on an image captured by an imaging unit in which a pattern is projected on the target object by a projection unit, the measurement unit measures a distance to the target object to acquire the measured distance as the measurement information.

5. The information processing apparatus according to claim 1, further comprising:
a measurement unit configured to acquire measurement information of the target object in a state of being held by the holding unit;
a relative position-and-orientation derivation unit configured to derive a relative position-and-orientation of a robot and the measurement unit in a robot coordinate system employing a position of a robot arm including the holding unit as a first reference, and a measurement coordinate system employing a position of the measurement unit as a second reference;
wherein the position-and-orientation acquisition unit acquires a position-and-orientation of the holding unit in the robot coordinate system;
wherein the target object position-and-orientation acquisition unit acquires a position-and-orientation of the target object in the measurement coordinate system;
wherein, based on the relative position-and-orientation of the robot and the measurement unit, the relative position-and-orientation derivation unit respectively converts the position-and-orientation of the holding unit in the robot coordinate system and the position-and-orientation of the target object in the measurement coordinate system into the position-and-orientations expressed by a same coordinate system, to derive the relative position-and-orientation from each of the converted position-and-orientations.

6. The information processing apparatus according to claim 1,
wherein the relative position-and-orientation derivation unit acquires a plurality of correspondences between the position-and-orientations of the holding unit acquired by the position-and-orientation acquisition unit and the position-and-orientations of the target object acquired by the target object position-and-orientation acquisition unit, and derives the relative position-and-orientation based on the plurality of acquired correspondences.

7. The information processing apparatus according to claim 1,
wherein, in a case where the target object has a rotationally-symmetrical shape, the target object position-and-orientation acquisition unit acquires a plurality of position-and-orientations of the target object, and
wherein the relative position-and-orientation derivation unit also derives a symmetrical axis for specifying rotational symmetry of the target object based on the plurality of acquired position-and-orientations of the target object.

8. The information processing apparatus according to claim 1,
a measurement unit configured to acquire measurement information of the target object in a state of being held by the holding unit;
wherein the relative position-and-orientation derivation unit acquires a plurality of correspondences between the position-and-orientations of the holding unit acquired by the position-and-orientation acquisition unit and the position-and-orientations of the target object acquired by the target object position-and-orientation acquisition unit, to also derive relative position-and-orientation of the robot and the measurement unit in the robot coordinate system employing the robot arm including the holding unit as a reference and the measurement coordinate system based on the plurality of acquired correspondences.

9. The information processing apparatus according to claim 1,
wherein the derived relative position-and-orientation is a teaching position-and-orientation used by the holding unit to grip the target object.

10. The information processing apparatus according to claim 1,
wherein the holding unit is a robot hand configured to hold the target object by gripping or sticking to the target object.

11. A robot system comprising:
the information processing apparatus according to claim 1; and
a holding unit provided on a robot arm, configured to hold a target object.

12. An information processing method comprising:
acquiring a position-and-orientation of a holding unit in a state of holding a target object;
acquiring a position-and-orientation of the target object in a state of being held by the holding unit; and
deriving a relative position-and-orientation of the holding unit and the target object based on the acquired position-and-orientation of the holding unit and the acquired position-and-orientation of the target object.

13. A non-transitory computer-readable storage medium storing a program for causing a computer, when executed, to function as each unit of the information processing apparatus according to claim 1.
